(19) United States
(12) Patent Application Publication
(10) Pub. No.: US 2026/0364829 A1
(43) Pub. Date: Nov. 19, 2026

(54) SUPPORT STRUCTURE FOR STATIONARY FOIL OF RECIPROCATING CUTTER HEAD AND RECIPROCATING CUTTER HEAD INCLUDING THE SAME

(71) Applicant: Zhejiang Jingbo Hardware Technology Co., Ltd., Lishui (CN)

(72) Inventors: Bingjie JIN, Lishui (CN); Zhijian JIN, Lishui (CN)

(21) Appl. No.: 19/730,858

(22) Filed: Jul. 3, 2026

(30) Foreign Application Priority Data
Jul. 4, 2025 (CN) 202521401927.6
Jul. 7, 2025 (CN) 202521411696.7

(51) Int. Cl. B26B 19/04; B26B 19/38

(52) U.S. Cl. CPC B26B 19/046; B26B 19/384

(57) ABSTRACT

A support structure for a stationary foil of a reciprocating cutter head is provided. The support structure is integrally formed, and includes an elongated support seat and two support frames respectively connected to two lateral sides of the support seat. Each support frame is formed by two support walls bending upwardly and extending from front and rear transverse edges of the support seat. Free ends of the two support walls are joined together at a position above a widthwise center of the support seat. A reciprocating cutter head includes a mounting seat formed by fixed connection of two coupling units, a stationary foil, a movable cutter, a reciprocating transmission member, and the support structure. The two coupling units are secured by a clamping member.

### CROSS-REFERENCE TO RELATED APPLICATIONS

This application claims the benefit of priority from Chinese Patent Application No. 202521401927.6, filed on Jul. 4, 2025 and Chinese Patent Application No. 202521411696.7, filed on Jul. 7, 2025. The content of the aforementioned application, including any intervening amendments made thereto, is incorporated herein by reference in its entirety.

### TECHNICAL FIELD

This application relates to reciprocating cutter heads for personal cleaning and care, and more particularly to a support structure for a stationary foil of a reciprocating cutter head and the reciprocating cutter head including the same.

### BACKGROUND

Conventional reciprocating shavers generally include a stationary foil, a plastic support base, and a movable cutter assembly. The stationary foil is typically formed by bending a thin metal sheet. Since the movable cutter is required to closely contact and cooperate with a bottom surface of the stationary foil to perform cutting, and a cutting edge of the movable cutter must precisely match the curvature of the stationary foil. During use, uneven loading applied to the stationary foil may result in increased operating current and, in severe cases, jamming of the shaver. Furthermore, prolonged use may cause deformation of the stationary foil, thereby reducing cutting efficiency and resulting in hair pulling or hair tugging. For a stationary foil formed by bending a thin metal sheet, after the stationary foil is mounted on a stationary cutter support, if the surface of the stationary foil is excessively loose, the movable cutter may become jammed against the stationary foil during use, or the stationary foil may exhibit a collapsed condition, thereby adversely affecting shaving performance and skin comfort. Conversely, if the stationary foil is excessively supported, the stationary foil may become overly rigid and susceptible to damage. This is because conventional stationary cutter supports generally provide fixed, or rigid, support. Spring members have been provided at opposite ends of the stationary cutter support. However, such arrangements merely allow the stationary foil as a whole to exhibit a certain degree of floating movement and are incapable of providing appropriate tensioning of the stationary foil. In addition, body-hair shavers are required to process hair that is generally finer and softer than facial hair, and skin contours vary significantly among different body regions. Accordingly, not only are there stringent requirements for cutting performance and skin comfort, but severed fine hairs also tend to accumulate in gaps formed by riveted or threaded connections, making cleaning difficult. Furthermore, riveted or threaded connections may inevitably cause deformation of components during assembly. After prolonged use, such deformed regions are more likely to become sites susceptible to failure or damage than other portions of the structure. Moreover, riveted or threaded connections occupy substantial internal space, make it difficult to maintain consistent assembly forces during mass production, and often result in complicated internal structures. Existing commercially-available reciprocating cutter heads generally cannot completely remove body hair of different lengths in a single cutting operation. Instead, two cutting units are often required, with one cutting unit configured to trim longer hairs and the other cutting unit configured to remove residual shorter hairs. The use of two cutting units requires two cutting blades and corresponding drive mechanisms, thereby increasing weight and making the shaver more susceptible to wear compared with a conventional single-function shaver. In addition, manufacturing and assembly costs are increased. Furthermore, operation of such a combined arrangement generally requires switching between different operating modes, which is time-consuming and cumbersome and often results in a poor user experience. Furthermore, a stationary foil having an irregular longitudinal cross-sectional profile inherently retains a transversely extending configuration and a lower opening regardless of how it is bent and formed. As a result, conventional support structures are generally unable to provide stable support for such a structure. In addition, because the support structure is an exposed component, it is susceptible to forces applied from various directions during use, which may deform the stationary foil formed from a bent thin metal sheet and adversely affect cooperation between the stationary foil and the movable cutter. In severe cases, the stationary foil may even become damaged or ruptured. Moreover, during assembly of the reciprocating cutter head, installation of components, such as the movable cutter, into a housing through the lower opening tends to distort the shape of an irregularly profiled stationary foil. Consequently, maintaining the intended shape of such an irregularly profiled stationary foil during assembly presents a significant challenge for manufacturers. This is also one of the reasons why conventional one-piece stationary foils are typically formed in generally n-shaped configurations.

In addition, conventional reciprocating shavers generally include a stationary foil, a plastic support base, and a movable cutter assembly. To ensure structural stability, a support structure for supporting the stationary foil is typically formed as a one-piece structure. A movable cutter mechanism is assembled within the integrally formed support structure, thereby imposing significant space limitations. Moreover, such a structure generally permits only top-to-bottom assembly. This assembly method is particularly unsuitable for a stationary foil integrally formed from a flexible thin metal sheet. In particular, for a stationary foil having an arcuate skin-contacting surface and side supporting surfaces that are not vertically oriented, the top-to-bottom assembly process may disrupt the predetermined curvature of the stationary foil and, in severe cases, may even cause fracture of the stationary foil, thereby increasing manufacturing costs. Furthermore, an integrally formed support structure is inconvenient to transport. Existing split-type support structures generally provide insufficient connection stability and are prone to disengagement. To enable pivotal movement of the cutter head, a Y-shaped pivotal support structure cooperating with left and right side walls of the support structure is commonly employed. In such a structure, the transverse length of the cutter head is limited. If a length of a cutting assembly is increased, the size of the Y-shaped pivotal support structure must correspondingly increase. As a result, the Y-shaped pivotal support structure occupies a substantial amount of internal space, causing the overall shaver to become undesirably wide. In addition, because the cutter head is positioned between two support arms of the Y-shaped pivotal support structure, it is difficult for the cutting assembly to project sufficiently outward to facilitate contact with the skin during cutting.

### SUMMARY

An object of the disclosure is to provide a support structure that provides appropriate support for a stationary foil, improves skin feel, has a stable structure, and is easy to manufacture and assemble, and a reciprocating cutter head including the support structure, so as to overcome the defects in the prior art.

Technical solutions of the present disclosure are described as follows.

In a first aspect, this application provides a support structure for a stationary foil of a reciprocating cutter head, the support structure being integrally formed, and the support structure comprising:
a support seat engaged within a mounting seat of the reciprocating cutter head and having an elongated shape; and
two support frames respectively connected to two sides of the support seat;
wherein a top wall of each of the two support frames is configured to fit an inner wall of a corresponding end portion of the stationary foil;
the two support frames are respectively located away from a skin-contacting region of the stationary foil having a plurality of receiving holes;
one of the two support frames is formed by two first support walls respectively formed by bending upward and extending from first end portions of a front transverse edge and a rear transverse edge of the support seat;
the other of the two support frames is formed by two second support walls respectively formed by bending upward and extending from second end portions of the front transverse edge and the rear transverse edge of the support seat;
free ends of the two first support walls are joined together in opposite directions at a position located above a widthwise center of a first end of the support seat; and free ends of the two second support walls are joined together in opposite directions at a position located above a widthwise center of a second end of the support seat;
the top wall of each of the two support frames is configured to fit the inner wall of the corresponding end portion of the stationary foil, and has a smooth and flat upper surface, such that the stationary foil is assembled onto the support structure by sliding engagement from a first end or a second end of the support structure in a lateral direction, thereby supporting the stationary foil and maintaining a configuration of the stationary foil.

In some embodiments, each of the two first support walls and the two second support walls, from bottom to top in sequence, comprises:
a raised portion formed by bending upward and outward from a corresponding end portion of a corresponding transverse edge of the support seat;
a connecting portion formed by bending backward in a straight return or an arc-shaped return from an end of the raised portion toward a center of the support seat; and
an abutting portion configured to abut against the inner wall of the corresponding end portion of the stationary foil and having a free end;
wherein abutting portions of the two first support walls are arranged opposite to each other, with free ends thereof joined together to define a first support surface; and abutting portions of the two second support walls are arranged opposite to each other, with free ends thereof joined together to define a second support surface.

In some embodiments, the support seat further comprises two extending portions respectively extending outwardly the front transverse edge and the rear transverse edge of the support seat;
two ends of one of the two extending portions are respectively connected to two raised portions at the front transverse edge, and two ends of the other of the two extending portions are respectively connected to two raised portions at the rear transverse edge; and
in a longitudinal section of the support seat, each of the two extending portion forms a continuous extension of a corresponding raised portion.

In some embodiments, the abutting portion is provided with a positioning groove; and
the positioning groove is formed at an outer edge of the abutting portion, and is accessible through an opening formed in the outer edge of the abutting portion.

In some embodiments, the positioning groove is provided with an anti-detachment constricted waist portion toward the opening in the outer edge of the abutting portion.

In a second aspect, this application provides a reciprocating cutter head, comprising:
the support structure described above;
the mounting seat formed by fixedly connecting two coupling units together;
the stationary foil;
a movable cutter having a cutting blade and fitting the stationary foil; and
a reciprocating transmission member;
wherein the stationary foil is an integrally-formed flexible metal sheet; and
the movable cutter and the reciprocating transmission member are provided within a cavity jointly defined by the mounting seat and the stationary foil.

In some embodiments, the reciprocating cutter head further comprises:
a clamping member;
wherein the clamping member is mounted on the mounting seat in a fully-surrounding manner or a semi-surrounding manner to at least partially surrounds the two coupling units in a lateral direction, such that, after the two coupling units are inserted into two sides of the stationary foil having the support structure transversely inserted therein and connected together to form the mounting seat, the two coupling units are clamped by the clamping member.

In some embodiments, each of the two coupling units comprises:
a base having a connecting arm; and
a retaining portion protruding from an end portion of the base and extending along a width direction of the stationary foil;
wherein an inner side wall of the retaining portion is protrudingly provided with a fixing portion in a suspended manner;
the fixing portion is configured to engage with a corresponding one of the two support frames;
an end portion of the connecting arm is provided with an insertion structure for connection of the two coupling units;
a first through hole is defined at a center of the mounting seat for a lower portion of the reciprocating transmission member to pass through;
an upper surface of the fixing portion is positioned below an upper surface of the retaining portion to form a stepped structure;
in response to a case that the fixing portion is engaged with the corresponding one of the two support frames, the retaining portion configured to seal a side edge of the stationary foil through the stepped structure; and
the fixing portion is provided with a limiting structure for securing the stationary foil.

In some embodiments, a protrusion is provided on an upper surface of the fixing portion spaced apart from the retaining portion, and is configured to engage with the positioning groove;
a height of the protrusion is less than a height difference between the upper surface of the fixing portion and the upper surface of the retaining portion; and
the protrusion and the positioning groove together define the limiting structure.

In some embodiments, a side surface of the retaining portion is provided wit a second through hole communicating with the cavity.

In some embodiments, two lug blocks are integrally formed on a lower portion of the base, and are symmetrically arranged along a lateral direction of the base;
below the base, the two lug blocks are movably connected to a swing bracket through a coupling structure;
the swing bracket is provided with two mounting arms opposite to each other;
the two mounting arms are rotatably connected to the mounting seat through the coupling structure;
a center of the swing bracket is rotatably sleeved with a transmission assembly for connecting the reciprocating transmission member with an external driving mechanism;
an elastic structure is provided between each of the two lug blocks and the swing bracket; and
the elastic structure is configured to prevent the mounting seat from swinging with respect to the swing bracket and to cause the mounting seat to return to an original position.

In some embodiments, the transmission assembly comprises:
a cylindrical rotary sleeve rotatably connected within a center hole of the swing bracket; and
an eccentric shaft eccentrically fixed on the cylindrical rotary sleeve; and
a bottom portion of the cylindrical rotary sleeve is a transmission groove for cooperating with the external driving mechanism to enable drivable connection;
the eccentric shaft is configured to cooperate with the reciprocating transmission member; and
the external driving mechanism is configured to drive the cylindrical rotary sleeve to rotate, such that the eccentric shaft drives the reciprocating transmission member to reciprocate laterally.

In some embodiments, an upper portion of the cylindrical rotary sleeve is provided with a plurality of engagement portions extending beyond an outer periphery of the cylindrical rotary sleeve;
the cylindrical rotary sleeve is engaged within the center hole through the plurality of engagement portions to rotatably mount the transmission assembly within the center hole; and
the plurality of engagement portions are engaged with a peripheral edge of the center hole by line contact fit.

In some embodiments, a clamping platform is integrally formed on a bottom surface of the base;
the clamping platform is configured to arranged along an outer periphery of the first through hole; and
the clamping member is mounted on a lower portion of the base along an outer periphery of the clamping platform in the fully-surrounding manner or the semi-surrounding manner, so as to at least partially surround the two coupling units in the lateral direction to fasten the two coupling units.

In some embodiments, an outer edge of the clamping platform is provided wit a plurality of hooks facing upwardly or toward the first through hole, thereby securing the clamping member to the mounting seat.

Compared to the prior art, the present disclosure has the following beneficial effects.
1. The support structure of the present disclosure provides appropriate support for a laterally extending, integrally formed stationary foil having a downwardly opening configuration. Because the support seat is generally in the form of an integral elongated body without segmented portions or breaks, the support structure exhibits improved flatness and prevents a joint from being directly subjected to vibration transmitted from a movable cutter or a transmission assembly, thereby reducing the likelihood of fracture and providing enhanced load-bearing capability and retention strength. In addition, the joint location of the support structure is provided on the support frame and is located at a symmetrical center of the support frame. The joint may be formed by ultrasonic welding at the symmetrical center of the support frame or on a lower surface of the support frame, thereby maintaining a smooth and flat upper surface of the support frame. Since the support frame is at least partially pressed against the mounting seat, the joint location is firmly secured.
2. The support frame formed by bending and joining the support walls not only satisfies the support requirements of a conventional n-shaped stationary foil, but also satisfies the support requirements of a stationary foil having irregular cross-sectional profiles. The support walls may be bent and joined in accordance with the cross-sectional profile of the stationary foil. The joint location of the support structure corresponds to a cross-sectional center region of the stationary foil, which serves as a sharp-feature avoidance region for improved skin comfort. The joint location is not subjected to interference from the reciprocating transmission member, thereby ensuring a secure connection, while allowing the support frame to fit the stationary foil. The support structure is particularly suitable for stationary foils having an arcuate skin-contact wall or multiple arcuate skin-contact walls. By increasing rigidity on two sides of the stationary foil, variations in curvature are significantly reduced, thereby improving cutting stability.
3. The support structure and the stationary foil are assembled by a sliding engagement in a lateral direction corresponding to a reciprocating direction. During the sliding assembly process, the support structure applies a pre-tension to the stationary foil without causing the stationary foil to become jammed. After assembly, a lower opening of the stationary foil is closed and the stationary foil is maintained in a desired shape. In addition, components such as the movable cutter may be assembled and mounted on the support structure through openings formed in the support seat. The movable cutter may thus be preliminarily assembled within the cavity through the sliding engagement between the support structure and the stationary foil.
4. The support structure not only tensions and supports the stationary foil, but also fixedly mounts the stationary foil to the mounting seat without the use of riveted connections or threaded connections. As a result, the stationary foil remains intact and is not damaged during assembly. Except for receiving holes, the stationary foil is free of additional notches or openings, thereby providing a skin-contact region having enhanced comfort. The stationary foil has a smooth surface free of sharp edges and burrs, allows a relatively large receiving area to be provided, and exhibits improved structural integrity, thereby significantly reducing the risk of skin injury and improving user comfort. In addition, the structure is convenient to manufacture and assemble.
5. The mounting seat formed by two coupling units fixedly connected together facilitates transportation of the coupling units in a separated state. During assembly, the two coupling units are slid into position from opposite sides toward a center region and secured together, thereby avoiding interference with the lower opening of the stationary foil. Accordingly, the structure readily accommodates stationary foils having irregular cross-sectional profiles, particularly stationary foils having an arcuate skin-contact surface.
6. The suspended arrangement of the fixing portion not only securely connects the stationary foil, but also leaves a greater volume within the cavity. As a result, unnecessary impacts between the movable cutter and the mounting seat are reduced, thereby significantly reducing perceived vibration and improving skin comfort.
7. The limiting structure for securing the stationary foil is arranged on the suspended fixing portion, allowing the limiting structure to be concealed and remain unexposed. The recessed and suspended configuration of the fixing portion also allows a side edge of the stationary foil to directly abut against a connection region between an inner side surface of the retaining portion and the fixing portion. Furthermore, because the mounting seat is formed from two connected coupling units, a retaining gap may be formed at the connection region between the retaining portion and the fixing portion to conceal and protect the side edge of the stationary foil. The structure is convenient to manufacture and easy to implement.
8. The reciprocating cutter head provided herein may be assembled without screws and, in some implementations, without adhesive bonding or threaded connections. This configuration is environmentally friendly and provides a secure and reliable connection. Furthermore, the internal structure is compact, well organized, and rationally arranged.

To facilitate a clearer understanding of the objectives, features, and advantages of the present disclosure, the present disclosure will be described in further detail below with reference to the accompanying drawings.

### BRIEF DESCRIPTION OF THE DRAWINGS

FIG. 1 is a structural view of a reciprocating cutter head according to an embodiment of the present disclosure;

FIG. 2 is a cross-sectional view along an A-A line in FIG. 1;

FIG. 3 is an exploded view of the reciprocating cutter head of FIG. 1;

FIG. 4 is a structural view of a reciprocating cutter head according to another embodiment of the present disclosure;

FIG. 5 is an exploded view of the reciprocating cutter head of FIG. 4;

FIG. 6 is a structural view of a transmission assembly; and

FIG. 7 is an exploded view of the transmission assembly of FIG. 6.

### DETAILED DESCRIPTION OF EMBODIMENTS

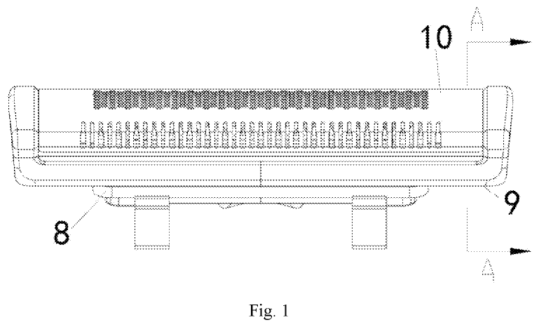

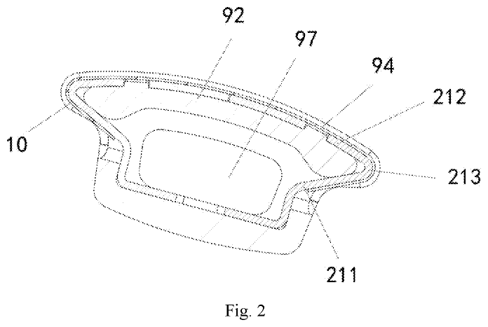

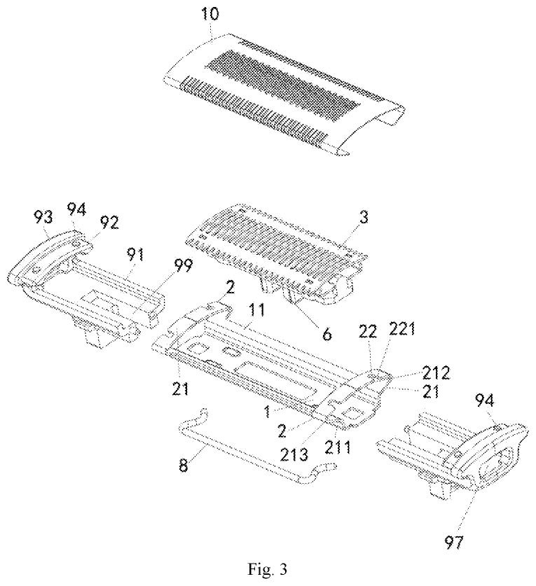

Referring to FIGS. 1-3, an embodiment of the present disclosure provides a support structure for a stationary foil of a reciprocating cutter head and a reciprocating cutter head. The reciprocating cutter head includes a mounting seat 9 formed by fixedly connecting two coupling units together, a stationary foil 10, a movable cutter 3 having a cutting edge and adapted to cooperate with the stationary foil 10, an elastic member, a movable-cutter holder, a support structure for the stationary foil, and a reciprocating transmission member 6. The stationary foil 10 is an integrally-formed flexible metal sheet. The movable cutter 3 and the reciprocating transmission member 6 are provided within a cavity jointly defined by the mounting seat 9 and the stationary foil 10. In this embodiment, the reciprocating cutter head is a hammer-shaped cutter head. Specifically, the stationary foil 10 includes a skin-contact wall provided with a plurality of first receiving holes, two inwardly converging walls respectively forming inwardly converging angles with two sides of the skin-contact wall, and two arcuate connecting walls respectively arcuately interconnecting the skin-contact wall and the inwardly converging walls. Free ends of the two inwardly converging walls are arranged spaced apart from each other below the skin-contact wall to define a lower opening of the stationary foil. The arcuate connecting walls are each provided with a plurality of second receiving holes. The skin-contact wall is an arcuate skin-contact wall extending in a transverse direction and having, in cross section, a curvature corresponding to that of the movable cutter. The support structure is integrally formed and includes a support seat 1 engaged within the mounting seat and having an elongated shape, and two support frames 2 respectively connected to two sides of the support seat 1. A top wall of each support frame is configured to fit an inner wall of a corresponding end portion of the stationary foil 10. The two support frames are respectively located away from the skin-contact wall of the stationary foil provided with the plurality of first receiving holes. One of the two support frames is formed by two first support walls 21 respectively formed by bending upward and extending from first end portions of a front transverse edge and a rear transverse edge of the support seat. The other of the two support frames is formed by two second support walls 21 respectively formed by bending upward and extending from second end portions of the front transverse edge and the rear transverse edge of the support seat. Free ends of the two first support walls are joined together in opposite directions at a position located above a widthwise center of a first end of the support seat. Free ends of the two second support walls are joined together in opposite directions at a position located above a widthwise center of a second end of the support seat. Free ends of the first two support walls are fixedly connected by ultrasonic welding. Free ends of the second two support walls are fixedly connected by ultrasonic welding. The top wall of each of the two support frames is configured to fit the inner wall of the corresponding end portion of the stationary foil, and has a smooth and flat upper surface, such that the stationary foil is assembled onto the support structure by sliding engagement from a left end or a right end of the support structure, thereby supporting the stationary foil and maintaining a configuration of the stationary foil.

In this embodiment, each coupling unit of the mounting seat 9 of the reciprocating cutter head includes a base 91 having a connecting arm and a retaining portion 93 protruding from an end portion of the base 91 and extending along a width direction of the stationary foil. An inner side wall of the retaining portion 93 is protrudingly provided with a fixing portion 92 in a suspended manner. The fixing portion 92 is configured to engage with a corresponding one of the two support frames 2. The fixing portion 92 is suspended with respect to the base 91 so as to provide clearance for the movable cutter and the movable-cutter holder. A side surface of the retaining portion 93 is provided with a first through hole 97. The first through hole 97 is an end-cap through hole, and communicates with the cavity, thereby facilitating cleaning and inspection of the cavity.

An end portion of the connecting arm is provided with an insertion structure for fixed connection of the two coupling units. The two coupling units are fixedly connected together through engagement of the insertion structures on the connecting arms. A second through hole 99 is defined at a center of the mounting seat 9 for a lower portion of the reciprocating transmission member 6 to pass through. The fixing portion 92 is provided with a limiting structure for securing the stationary foil. An upper surface of the fixing portion is positioned below an upper surface of the retaining portion to form a stepped structure. When the fixing portion 92 is engaged with the corresponding one of the support frames 2, the retaining portion 93 is configured to seal a side edge of the stationary foil 10 through the stepped structure. To improve skin comfort, exposed portions of the retaining portion 93 facing the stationary foil 10, such as a corner between an inner side surface and an upper surface of the retaining portion 93 and an outer surface of the retaining portion 93, are provided with arcuate transitions or chamfered transitions.

In this embodiment, each support wall 21 is formed by bending and extending generally upwardly from the end portion of the corresponding transverse edge of the support seat. Each of the two first support walls 21 and the two second support walls, from bottom to top in sequence, includes: a raised portion 211 formed by bending upward and outward from a corresponding end portion of the corresponding transverse edge of the support seat, a connecting portion 213 formed by bending backward in a straight return or an arc-shaped return from an end of the raised portion 211 toward a center of the support seat, and is configured to fit the arcuate connecting wall of the stationary foil, and an abutting portion 212 configured to abut against an inner wall of the corresponding end portion of the stationary foil 10 and having a free end. Abutting portions 212 of the two first support walls 21 are arranged opposite to each other, with free ends thereof joined together to define a first support surface, and abutting portions 212 of the two second support walls 21 are arranged opposite to each other, with free ends thereof joined together to define a second support surface. The support seat 1 further includes two extending portions 11 extending outwardly from portions of the front transverse edge and the rear transverse edge of the support seat. Two ends of one of the two extending portions 11 are respectively connected to two raised portions 211 at the front transverse edge, and two ends of the other of the two extending portions 11 are respectively connected to two raised portions 211 at the rear transverse edge. In a longitudinal section of the support seat, each extending portion 11 forms a continuous extension of a corresponding raised portion 211. The extending portions 11 are formed by portions of the support seat 1 extending upwardly and outwardly from the front transverse edge and the rear transverse edge thereof, and are configured to be received within the lower opening of the stationary foil. End portions of the inwardly converging walls are configured to be pressed against the extending portions 11. The extending portions 11 cooperate with the mounting seat such that the inwardly converging walls at an edge of the lower opening of the stationary foil are clamped and positioned between the extending portions 11 and the mounting seat. As a result, deformation and edge lifting of the inwardly converging walls at the lower opening can be effectively prevented, thereby further ensuring the flatness of the stationary foil on the cutter head, operational safety, and skin comfort.

In this embodiment, the stationary foil is fixedly mounted on the mounting seat via the support structure to ensure integrity of the stationary foil. The support seat 1 is fitted into the base 91 of the mounting seat, and the support frames 2 of the support structure are connected to corresponding fixing portions of the mounting seat via a snap-fit groove structure. Specifically, the abutting portion 212 is provided with a positioning groove 22. The positioning groove 22 is formed at an outer edge of the abutting portion 212, and is accessible via an opening formed in the outer edge of the abutting portion. The positioning groove 22 is provided with an anti-detachment constricted waist portion 221 toward the opening in the outer edge of the abutting portion. A protrusion 94 is provided on an upper surface of the fixing portion spaced apart from the retaining portion, and is configured to engage with the positioning groove 22. A height of the protrusion 94 is lower than a height difference between the upper surface of the fixing portion and the upper surface of the retaining portion. After the protrusion 94 enters the positioning groove 22 through the opening, the anti-detachment constricted waist portion 221 partially prevent disengagement of the mounting seat. Locking of the split mounting seat in an assembled state is achieved by an interference-fit or snap-fit structure provided at end portions of the connecting arms of the two coupling units. To further improve stability after assembly, a clamping member 8 is additionally provided. The clamping member 8 is mounted on the mounting seat 9 in a fully-surrounding manner or a semi-surrounding manner to at least partially surrounds the two coupling units in a lateral direction, such that after the two coupling units are inserted into left and right sides of the stationary foil having the support structure transversely inserted therein and connected together to form the mounting seat 9, the two coupling units are clamped by the clamping member 8. In some embodiments, the clamping member 8 is a strip spring. In this embodiment, the clamping member 8 is exposed for clarity, but may alternatively be embedded in a hidden manner for aesthetic purposes.

The stationary foil of the reciprocating cutter head provided herein is resistant to deformation as a whole. A thickness of the stationary foil may be reduced to less than 10 silk, and even to 4-5 silk, thereby achieving an ultra-thin structure that cannot be realized by conventional manufacturing processes. As a result, the reciprocating cutter head exhibits enhanced cutting sharpness and provides a cleaner shave. Meanwhile, the sufficient supporting force enables the stationary foil to have a longer service life, thereby ensuring cutting sharpness and safety of the reciprocating cutter head.

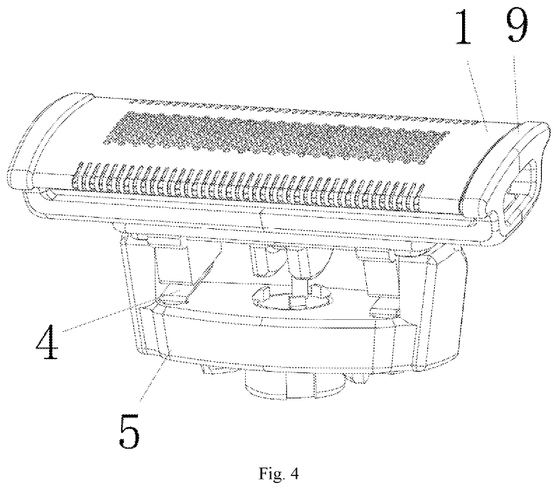

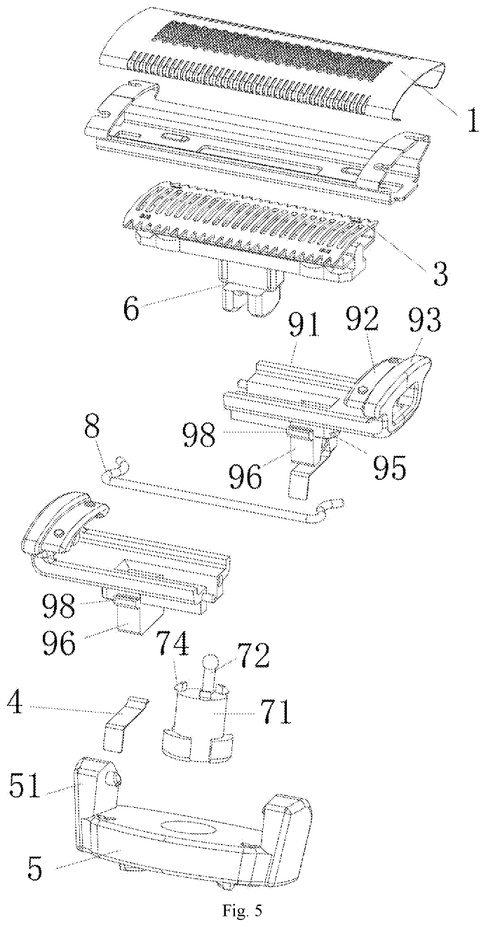

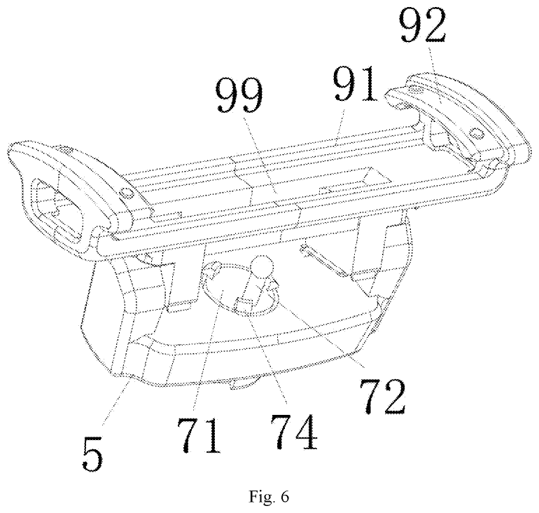

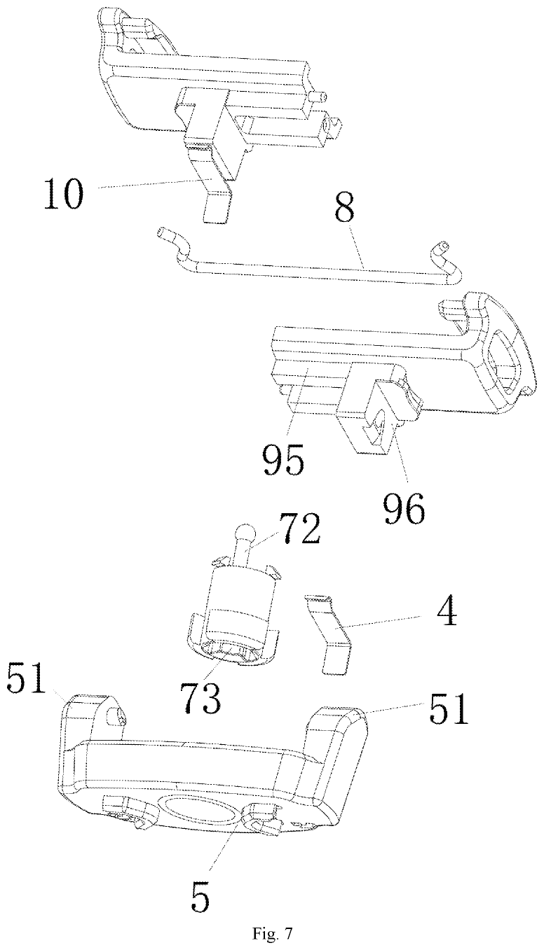

As shown in FIGS. 4-7, another embodiment of the reciprocating cutter head is provided. A clamping platform 95 is integrally formed on a bottom surface of the base 91. The clamping platform 95 is configured to arranged along an outer periphery of the second through hole 99. The clamping member 8 is mounted on a lower portion of the base 91 along an outer periphery of the clamping platform 95 in the fully-surrounding manner or the semi-surrounding manner, so as to at least partially surround the two coupling units in the lateral direction to fasten the two coupling units. The clamping platform 95 facilitates installation of the clamping member 8. For ease of illustration, the clamping platform 95 and the clamping member 8 are shown in an exposed configuration in this embodiment. In practical applications, the clamping platform 95 and the clamping member 8 may be concealed to improve appearance. In some embodiments, the clamping member 8 is a bent strip spring. In this embodiment, an outer edge of the clamping platform 95 is provided with a plurality of hooks 98 facing upwardly or toward the second through hole 99, such that the clamping member 8 is retained on the mounting seat 9. The hooks 98 serve to position the clamping member 8. In addition to the insertion structures, the clamping member 8 provides an additional safeguard for laterally securing the connection between the two coupling units.

In this embodiment, two lug blocks 96 are integrally formed on a lower portion of the clamping platform 95 of the base 91, and are symmetrically arranged along a lateral direction of the base 91. Below the base, the two lug blocks 96 are movably connected to a swing bracket 5 through a coupling structure. The swing bracket 5 is provided with two mounting arms 51 opposite to each other. The mounting arms 51 are rotatably connected to the mounting seat 9 through the coupling structure. A center of the swing bracket 5 is rotatably sleeved with a transmission assembly for connecting the reciprocating transmission member 6 with an external driving mechanism. In this embodiment, the two lug blocks 96 are provided at a central portion of a bottom of the base 91 of the mounting seat, and a pivotable supporting connection is established through the swing bracket 5. Such an arrangement occupies less space, thereby increasing the exposed portion of the skin-contact cutting assembly and improving contact performance with the skin. The skin-contact cutting assembly is formed by the stationary foil, the movable cutter and the support seat. In addition, the structure is simple, easy to implement, and capable of reducing manufacturing costs.

The transmission assembly includes a cylindrical rotary sleeve 71 rotatably connected within a center hole of the swing bracket 5, an eccentric shaft 72 eccentrically fixed on the cylindrical rotary sleeve 71. A bottom portion of the cylindrical rotary sleeve 71 is a transmission groove for cooperating with the external driving mechanism to enable drivable connection. The eccentric shaft 72 is configured to cooperate with the reciprocating transmission member 6. The external driving mechanism drives the cylindrical rotary sleeve 71 to rotate, such that the eccentric shaft 72 drives the reciprocating transmission member 6 to move leftward and rightward. An elastic structure 4 is provided between each lug block 96 and the swing bracket 5. The elastic structure 4 is configured to prevent the mounting seat from swinging with respect to the swing bracket and to cause the mounting seat to return to an original position. In this embodiment, the elastic structure 4 is a leaf spring formed by bending. Owing to the provision of the elastic structure 4, the cutting assembly at an upper portion of the cutter head is capable of swinging within a predetermined angular range and automatically returning to its original position. When mounted on a handle for use, the cutter head can be conveniently adjusted to different angles for shaving different portions of a user's body. During swinging, a certain degree of resilient damping is provided, thereby significantly reducing abruptness of the swinging motion and improving shaving comfort.

An upper portion of the cylindrical rotary sleeve 71 is provided with three engagement portions 74 extending beyond an outer periphery of the cylindrical rotary sleeve 71. In this embodiment, the engagement portions 74 are integrally formed with the cylindrical rotary sleeve 71. The eccentric shaft 72 is fixedly retained within the cylindrical rotary sleeve 71 and extends outwardly therefrom. The cylindrical rotary sleeve 71 is engaged within the center hole through the engagement portions to rotatably mount the transmission assembly within the center hole. A lower surface of each engagement portion 74 is arcuate. The engagement portions 74 are engaged with a peripheral edge of the center hole by line contact fit or point contact fit. In some embodiments, the transmission groove 73 is in line contact or point contact with a lower surface of the swing bracket 5. As a result, power loss is reduced, the transmission is smoother, and operating noise is lowered. In addition, assembly is facilitated, the structure is compact and simple, the appearance is aesthetically pleasing, and manufacturing and processing are convenient.

Described above are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A support structure for a stationary foil of a reciprocating cutter head, the support structure being integrally formed, and the support structure comprising:
a support seat engaged within a mounting seat of the reciprocating cutter head and having an elongated shape; and
two support frames respectively connected to two sides of the support seat;
wherein a top wall of each of the two support frames is configured to fit an inner wall of a corresponding end portion of the stationary foil;
the two support frames are respectively located away from a skin-contacting region of the stationary foil having a plurality of hair receiving holes;
one of the two support frames is formed by two first support walls respectively formed by bending upward and extending from first end portions of a front transverse edge and a rear transverse edge of the support seat;
the other of the two support frames is formed by two second support walls respectively formed by bending upward and extending from second end portions of the front transverse edge and the rear transverse edge of the support seat;
free ends of the two first support walls are joined together in opposite directions at a position located above a widthwise center of a first end of the support seat; and
free ends of the two second support walls are joined together in opposite directions at a position located above a widthwise center of a second end of the support seat;
the top wall of each of the two support frames is configured to fit the inner wall of the corresponding end portion of the stationary foil, and has a smooth and flat upper surface, such that the stationary foil is assembled onto the support structure by sliding engagement from a first end or a second end of the support structure in a lateral direction, thereby supporting the stationary foil and maintaining a configuration of the stationary foil.

2. The support structure of claim 1, wherein each of the two first support walls and the two second support walls, from bottom to top in sequence, comprises:
a raised portion formed by bending upward and outward from a corresponding end portion of a corresponding transverse edge of the support seat;
a connecting portion formed by bending backward in a straight return or an arc-shaped return from an end of the raised portion toward a center of the support seat; and
an abutting portion configured to abut against the inner wall of the corresponding end portion of the stationary foil and having a free end;
wherein abutting portions of the two first support walls are arranged opposite to each other, with free ends thereof joined together to define a first support surface; and abutting portions of the two second support walls are arranged opposite to each other, with free ends thereof joined together to define a second support surface.

3. The support structure of claim 2, wherein the support seat further comprises two extending portions respectively extending outwardly the front transverse edge and the rear transverse edge of the support seat;
two ends of one of the two extending portions are respectively connected to two raised portions at the front transverse edge, and two ends of the other of the two extending portions are respectively connected to two raised portions at the rear transverse edge; and
in a longitudinal section of the support seat, each of the two extending portions forms a continuous extension of a corresponding raised portion.

4. The support structure of claim 2, wherein the abutting portion is provided with a positioning groove; and
the positioning groove is formed at an outer edge of the abutting portion, and is accessible through an opening formed in the outer edge of the abutting portion.

5. The support structure of claim 4, wherein the positioning groove is provided with an anti-detachment constricted waist portion toward the opening in the outer edge of the abutting portion.

6. A reciprocating cutter head, comprising:
the support structure of claim 4;
the mounting seat formed by fixedly connecting two coupling units together;
the stationary foil;
a movable cutter having a cutting blade and fitting the stationary foil; and
a reciprocating transmission member;
wherein the stationary foil is an integrally-formed flexible metal sheet; and
the movable cutter and the reciprocating transmission member are provided within a cavity jointly defined by the mounting seat and the stationary foil.

7. The reciprocating cutter head of claim 6, further comprising:
a clamping member;
wherein the clamping member is mounted on the mounting seat in a fully-surrounding manner or a semi-surrounding manner to at least partially surrounds the two coupling units in a lateral direction, such that after the two coupling units are inserted into two sides of the stationary foil having the support structure transversely inserted therein and connected together to form the mounting seat, the two coupling units are clamped by the clamping member.

8. The reciprocating cutter head of claim 6, wherein each of the two coupling units comprises:
a base having a connecting arm; and
a retaining portion protruding from an end portion of the base and extending along a width direction the stationary foil;
wherein an inner side wall of the retaining portion is protrudingly provided with a fixing portion in a suspended manner;
the fixing portion is configured to engage with a corresponding one of the two support frames;
an end portion of the connecting arm is provided with an insertion structure for fixed connection of the two coupling units;
a first through hole is defined at a center of the mounting seat for a lower portion of the reciprocating transmission member to pass through;
an upper surface of the fixing portion is lower than an upper surface of the retaining portion to form a stepped structure;
in response to a case that the fixing portion is engaged with the corresponding one of the two support frames, the retaining portion is configured to seal a side edge of the stationary foil through the stepped structure; and
the fixing portion is provided with a limiting structure for securing the stationary foil.

9. The reciprocating cutter head of claim 8, wherein a protrusion is provided on an upper surface of the fixing portion spaced apart from the retaining portion, and is configured to engage with the positioning groove;
a height of the protrusion is less than a height difference between the upper surface of the fixing portion and the upper surface of the retaining portion; and
the protrusion and the positioning groove together define the limiting structure.

10. The reciprocating cutter head of claim 8, wherein a side surface of the retaining portion is provided with a second through hole communicating with the cavity.

11. The reciprocating cutter head of claim 8, wherein two lug blocks are integrally formed on a lower portion of the base, and are symmetrically arranged along a lateral direction of the base;
below the base, the two lug blocks are movably connected to a swing bracket through a coupling structure;
the swing bracket is provided with two mounting arms opposite to each other;
the two mounting arms are rotatably connected to the mounting seat through the coupling structure; and
a center of the swing bracket is rotatably sleeved with a transmission assembly for connecting the reciprocating transmission member with an external driving mechanism.

12. The reciprocating cutter head of claim 11, wherein the transmission assembly comprises:
a cylindrical rotary sleeve rotatably connected within a center hole of the swing bracket; and
an eccentric shaft eccentrically fixed on the cylindrical rotary sleeve;
a bottom portion of the cylindrical rotary sleeve is a transmission groove for cooperating with the external driving mechanism to enable drivable connection;
the eccentric shaft is configured to cooperate with the reciprocating transmission member; and
the external driving mechanism is configured to drive the cylindrical rotary sleeve to rotate, such that the eccentric shaft drives the reciprocating transmission member to reciprocate laterally.

13. The reciprocating cutter head of claim 12, wherein an upper portion of the cylindrical rotary sleeve is provided with a plurality of engagement portions extending beyond an outer periphery of the cylindrical rotary sleeve; and
the cylindrical rotary sleeve is engaged within the center hole through the plurality of engagement portions to rotatably mount the transmission assembly within the center hole.

14. The reciprocating cutter head of claim 13, wherein the plurality of engagement portions are engaged with a peripheral edge of the center hole by line contact fit.

15. The reciprocating cutter head of claim 11, wherein an elastic structure is provided between each of the two lug blocks and the swing bracket; and
the elastic structure is configured to prevent the mounting seat from swinging with respect to the swing bracket and to cause the mounting seat to return to an original position.

16. The reciprocating cutter head of claim 8, wherein a clamping platform is integrally formed on a bottom surface of the base;
the clamping platform is arranged along an outer periphery of the first through hole; and
the clamping member is mounted on a lower portion of the base along an outer periphery of the clamping platform in the fully-surrounding manner or the semi-surrounding manner, so as to at least partially surround the two coupling units in the lateral direction to fasten the two coupling units.

17. The reciprocating cutter head of claim 15, wherein a clamping platform is integrally formed on a bottom surface of the base;
the clamping platform is arranged along an outer periphery of the first through hole; and
the clamping member is mounted on a lower portion of the base along an outer periphery of the clamping platform in the fully-surrounding manner or the semi-surrounding manner, so as to at least partially surround the two coupling units in the lateral direction to fasten the two coupling units.

18. The reciprocating cutter head of claim 16, wherein an outer edge of the clamping platform is provided with a plurality of hooks facing upwardly or toward the first through hole, thereby securing the clamping member to the mounting seat.

19. The reciprocating cutter head of claim 17, wherein an outer edge of the clamping platform is provided with a plurality of hooks facing upwardly or toward the first through hole, thereby securing the clamping member to the mounting seat.
